(19) United States
(12) Patent Application Publication
(10) Pub. No.: US 2018/0082242 A1
(43) Pub. Date: Mar. 22, 2018

(54) DATA-DRIVEN TRAINING AND COACHING SYSTEM AND METHOD

(71) Applicant: LucidLift LLC, Bloomington, MN (US)

(72) Inventors: Mark STRANGE, Bloomington, MN (US); Paul CARLSON, Woodbury, MN (US)

(21) Appl. No.: 15/713,349

(22) Filed: Sep. 22, 2017

Related U.S. Application Data
(60) Provisional application No. 62/398,472, filed on Sep. 22, 2016.

(51) Int. Cl. G06Q 10/06; G06F 9/44; G06F 15/18

(52) U.S. Cl. CPC G06Q 10/063118; G06F 9/4446; G06F 8/20; G06F 15/18; G06Q 10/06315

(57) ABSTRACT

A data-driven training and coaching (DDTC) method, platform, and system includes collecting data from teams at a company, including from any Agile tools being used. The DDTC system imports and converts the data to a common format, reports on the progress of the teams, uses an artificial intelligence processor to determine how the team is performing, and then sends targeted training and coaching tips to members of the team. The DDTC system also detects problems as they occur and sends alerts to members recommending specific actions. The DDTC system is adaptable to or implemented with other disciplines as well.

### PRIORITY

This application claims priority to and the benefit of U.S. Provisional Patent Application No. 62/398,472, filed Sep. 22, 2016, which is incorporated fully herein by reference.

### FIELD

The present invention generally relates to software development systems and processes and, more particularly, to using artificial intelligence and other processing features in the training and coaching of software development teams according to Agile principles.

### BACKGROUND

There have been numerous attempts to manage the software development process. One of the current development processes is referred to as “Agile.” Agile software development describes a set of principles for software development under which requirements and solutions evolve through the collective effort of the development teams. Agile software development began its rise to popularity well over a decade ago, and now nearly every company that develops software uses some form of Agile software development.

In the vast majority of implementations of Agile, team members and managers do not fully understand fundamental Agile principles, thus leading to critical mistakes. In many cases, organizations end up abandoning Agile and reverting to traditional (e.g., waterfall) and more expensive ways of working, but only after spending thousands, or even millions, of dollars on failed Agile projects and teams. Managers and executives, who usually have received less than a single two-day Agile training class, do not have proper visibility into and understanding of how their teams are performing. This leads to uninformed decisions that have a detrimental effect on their teams and projects.

Many organizations employ a combination of in-person or online training and on-site coaching. Staff members are usually sent to a two-day class, after which they are “certified” in Agile software development. These classes are expensive, both in direct cost and lost staff productivity, so managers typically train only a few key individuals, hoping that the information can be dispersed from these individuals to the other team members. While there is nothing inherently wrong with these classes, they are not sufficient to produce deep and broad understanding across the entire team and management, which would increase the likelihood of successful projects. Moreover, even if someone could absorb all of the information that they need in two days, they are not likely to know how to apply it when they encounter real problems with their teams and projects.

Follow-on coaching has weaknesses as well. First, there are very few coaches that have the background, understanding, and experience to really have an impact. There are a handful of good Agile coaches, most of them working as independent consultants or for consulting firms. Second, good Agile coaching is expensive (typically around $100+ per hour). Third, coaches cannot be everywhere at once, so their impact is limited since the coach can really only focus on one team at a time. For example, most organizations will hire a single coach for several teams, which dilutes the effectiveness of the coaching. It is also typical to see Agile techniques unwind after the coach leaves.

Agile “tools” have been developed (e.g., CA Agile Central™, Atlassian Jira™, and VersionOne™), but they are focused on simply aggregating and holding team information in a database and producing basic reports. These tools do not have the capability to analyze the quality of the data being entered and, in fact, there is an incentive for them not to enforce any data input structure because it allows more people to use the tool however they see fit, even if their use of the tool could be harming their software development efforts. Because the quality of the data is not enforced, the tools are used just as an information repository, and do not assist organizations in dynamically improving their Agile practices.

There is no current solution that provides targeted training to a team driven by data.

### SUMMARY

A data-driven training and coaching (DDTC) method, platform, and system includes collecting data from all teams at a company, and from any Agile tools being used. The DDTC imports and converts the data to a common format, reports on the progress of the teams, uses a rules engine or artificial intelligence processor to determine how the team is performing, then sends targeted training and coaching tips to subscribers/users (members of the software development team or management team). The DDTC system also detects problems as they occur and sends alerts to subscribers recommending specific actions.

The present invention provides automated training and coaching to teams with an empirical process that promotes transparency, inspection, and adaptation based on the system's processing and analysis. Risk is lowered by having more inspection points for action. The artificial intelligence of the present system monitors and recognizes how a team is doing and provides teaching and coaching assistance accordingly.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 shows a hardware and system diagram for a DDTC system and method, in accordance with embodiments of the present invention.

FIG. 2 shows a logic diagram for a DDTC system and method, in accordance with embodiments of the present invention.

FIG. 3 shows a training loop diagram, in accordance with embodiments of the present invention.

FIG. 4 shows a process diagram for a DDTC system and method, in accordance with embodiments of the present invention.

FIG. 5 shows a list of exemplary rules for an artificial intelligence processor of a DDTC system and method, in accordance with embodiments of the present invention.

FIG. 6 shows a list of exemplary options that may be presented to a user for selection for an DDTC system and method, in accordance with embodiments of the present invention.

FIG. 7 shows a logic diagram illustrating the general use of data to derive facts and create actions, in accordance with embodiments of the present invention.

FIG. 8 shows a logic diagram illustrating the specific use of data to derive facts and create actions based on a “good user story” determination, in accordance with embodiments of the present invention.

FIG. 9 shows a logic diagram of an artificial intelligence processor, in accordance with embodiments of the present invention.

FIG. 10 shows a user main dashboard screenshot, in accordance with embodiments of the present invention.

FIG. 11 shows a user project dashboard screenshot, in accordance with embodiments of the present invention.

FIG. 12 shows a “sprint details” screenshot for an exemplary project, in accordance with embodiments of the present invention.

FIG. 13 shows a “product backlog” screenshot for an exemplary project, in accordance with embodiments of the present invention.

FIG. 14 shows a “defect backlog” screenshot for an exemplary project, in accordance with embodiments of the present invention.

FIG. 15 shows an “alerts” screenshot for an exemplary project, in accordance with embodiments of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

In the following descriptions, the present invention will be explained with reference to example embodiments thereof. However, these embodiments are not intended to limit the present invention to any specific example, embodiment, environment, applications or particular implementations described in these embodiments. Therefore, description of these embodiments is only for purpose of illustration rather than to limit the present invention.

The data-driven training and coaching (DDTC) platform or system 100 of the present invention utilizes backlog data from any of the Agile tools known, implemented, or identified herein, from a simple spreadsheet, or from like data sources. The DDTC platform 100 will produce reporting at the enterprise level (even if an organization happens to be using multiple tools). Unlike traditional coaching and training methods, the present system can elevate the performance of software teams at scale, and at a fraction of the cost of actual Agile coaches. The present invention implements and leverages artificial intelligence (Al) to glean facts from backlogs, and uses these facts to set goals. From these goals, targeted training content is delivered to the users, with immediate feedback provided during Agile “sprints” in the form of alerts and reports.

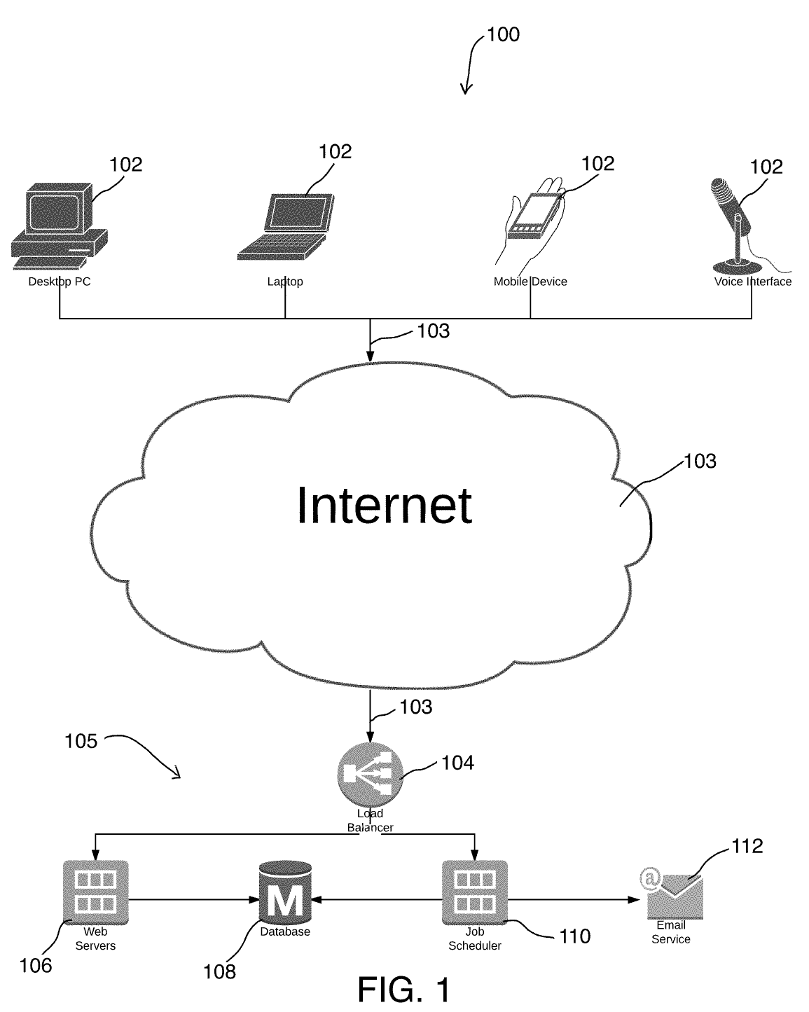

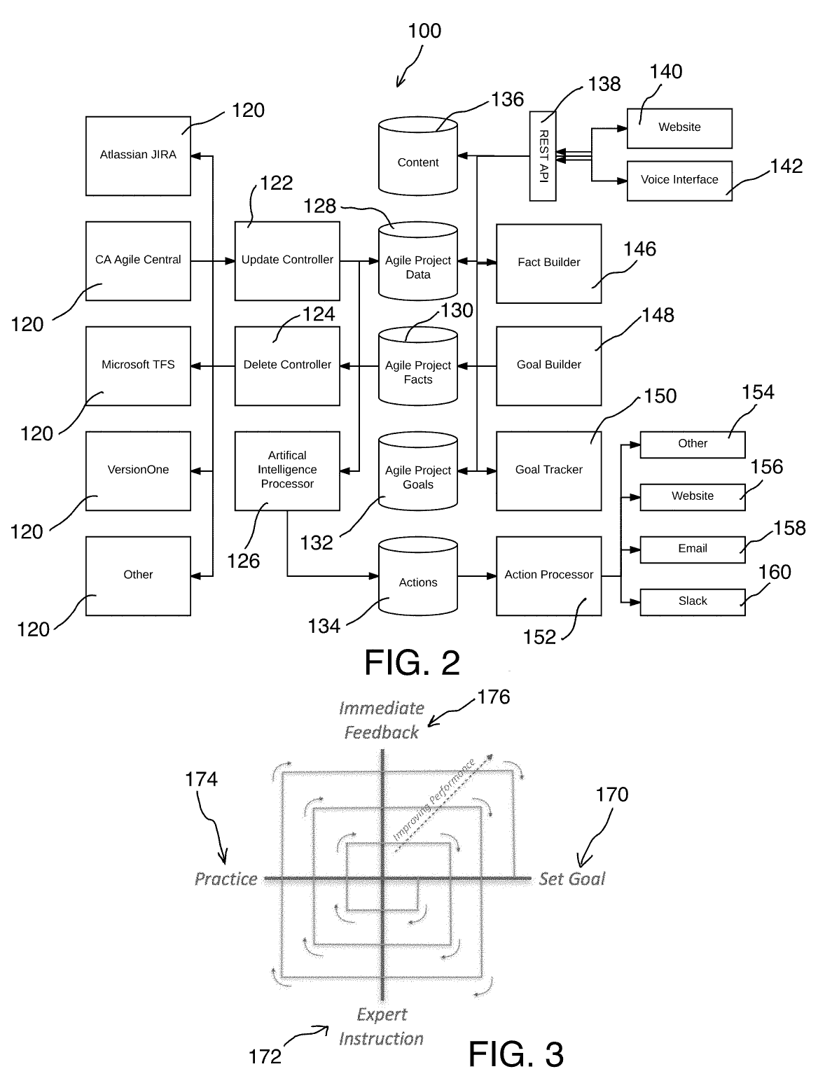

Referring to FIGS. 1-2, the hardware/software processing architecture of the DDTC system 100 is shown in relationship to user interfaces with Agile databases from which the system downloads backlog data. FIG. 3 illustrates the training loop 104 employed by the DDTC system 100.

As shown in FIG. 1, one or more client interfaces or user/client devices or interfaces 102 are in operative communication with one or more system servers 106 via a network 103, such as the Internet. In various embodiments, the server side 105 of the system can include a load balancer 104, one or more databases 108, one or more job schedulers 110, and one or more message or notification servers/services 112.

The DDTC user interface or devices 102 can be the team member user's individual computing station, terminal, tablet, laptop, mobile computing device, voice interface, and the like. The user logs into the DDTC system 100 via a web browser or other interface using their individual credentials. The credentials can be provided as part of a subscription package or other monetization of the DDTC platform and methods. In another embodiment, a software application can be downloaded to the user's computing device for interaction and processing through the system 100. The local application on the device 102 will then communicate with the DDTC-side software and servers 105 to perform the methods and functionality disclosed herein.

The information and data stored on the databases 108 can be imported from a combination of multiple tools (e.g., Atlassian Jira™, VersionOne™, Microsoft Team Services™, CA Agile Central™, etc.). Moreover, spreadsheet, XML, CSV, or other data files or inputs can be provided to the DDTC platform as well. The databases 108 are memory or storage, and can include “cloud” storage.

The computing systems on the server side 105 comprise a microprocessor and non-transitory memory. Software code is stored in the non-transitory memory and executed by the microprocessor such that the DDTC system 100 functions and operates according to the methods and processes described herein and in the figures. One or more various subsystems can be integrated with these computing systems. The computing systems can also generally designate a plurality of processors and memory storages for employment and use.

In one embodiment, The DDTC system 100 is configured as a software-as-a-service (SaaS) configuration where the physical components of the DDTC are not located in the client's facility. Access to and communication with the DDTC system 100 is provided via the Internet 103. Thus, a network interface is coupled to, or integrated into, the computing systems for communication with a network interface provided with the client devices 102 (e.g., wired or wireless communication).

Data import and conversion components and software function to extract the backlog data. The backlog data can be converted into a uniform format for analysis by the system rules engine or Al processor, as detailed herein. The conversion can be via XML translation or other translation means. The data storage 108, such as cloud storage, is where the backlog data generated by the Agile tools is stored for use by the DDTC system 100. The storage 108 can also comprise local storage and/or remote storage devices or networks.

One or more databases, such as databases 108, contain coaching or training materials. These databases can physically reside within the DDTC computing systems or can include one or more remotely-located or cloud databases. The training materials can include articles, presentations, video clips, combinations thereof, and like electronic media or materials. The training materials are selected via the processing and analysis of the Al processor based on data from the backlog and are served to target team members via the message server or service 112. The actual training materials, or portions thereof, can be enclosed within the messages (e.g., email, text, messages, etc.) sent to the team members at devices 102. Alternatively, the messages can include a hyperlink, or like linking or imbedded technology, to the subject training materials. The training materials can also include tests or quizzes to check or verify the user's mastery of the training materials.

The rules engine or Al processor of the present system 100 comprises a set of logic rules programmed into the software. The engine processes and analyzes the data stored in the storage 108 and initiates and outputs training information to selected team members. The Al processor is explained in more detail herein.

The user may also be provided with a software dashboard that allows for the user to manually select various training materials based upon topic, keyword, natural language, stage, etc. The dashboard and other user software interfaces for the system 100 are further detailed herein.

FIG. 2 illustrates the operation and functionality of the DDTC system 100. A plurality of software and/or project management toolsets (sources) are made available and polled by the system 100 to obtain Agile project information. While the various available sources are identified as Atlassian Jira™, CA Agile Central™, Microsoft TFS™, and VersionOne™, the system 100 can connect to and extract information from virtually any tool or system to the extent that tool exposes an application programming interface (API).

The update controller 122 is in operative communication with and polls the source systems 120 to receive new or updated project information. This information is then mapped into a unique or propriety data structure by the system 100 and stored in an Agile project data repository 128. The update controller 122 operates on a scheduled basis that can be defined by the user, or automatically.

The delete controller 124 is in operative communication with and polls the source systems 120 to determine if the source data still exists. If the source data does not exist, the system 100 will logically delete (e.g., mark inactive) the source data in the agile project data repository 128.

The Al processor 126 includes the expert rules as they pertain to Agile coaching and scrum best practice, as described herein. The Al processor processes and evaluates the facts produced by the fact builder 146, thereby creating actions 134 for the action processor 152.

The content data repository 136 is the storage location for the “expert instruction” content as described by the deliberate practice loop of FIG. 3. Goals and feedback (e.g., in the form of alerts) link to content to provide the expert instruction. Further, “smart content” can include augmenting of the expert instruction with facts gleaned and processed from the project through the fact builder 146.

The Agile project data repository 128 includes the customer Agile project data plus the audit records of that data. The system 100 processes and tracks changes to the Agile data as it occurs over time and that temporal information is processed by the fact builder 146 to create facts of a temporal nature. The Agile project fact repository 130 includes the facts that the fact builder 146 processes and gleans from Agile project data 130. The system 100 can derive over 100 different types of facts from Agile data in various embodiments. All fact data can be also audited so such that the system 100 includes all relevant information to determine how facts pertaining to a project change over time.

The goal repository 132 stores the goals the goal builder 148 generates or creates for a team. As per the deliberate practice loop of FIG. 3, the goal builder analyzes the facts about a project and creates goals for the team to work on to improve. The goal tracker 150 component measures or monitors progress against those goals and, when complete, the goal builder 148 can create a new goal for the team of increasing difficulty. Goals are linked to expert instruction material and media provided in the content repository 136. The action repository 134 stores the actions the Al processor 126 creates in order to provide feedback to the team of users as they are sprinting, per the deliberate practice loop. This feedback is linked to expert instruction material from the content repository 136.

Requests for data from the system 100 flow through the representational state transfer (REST) API 138. Requests for data can come from a website for the system 100, or from other sources such as a voice interface such as Alexa™, Siri™, Cortana™, Google Assistant™, etc. The data returned from the API 138 can be provided in Javascript Object Notation (JSON) or a myriad of other known formats.

The fact builder 146 processes and analyzes Agile project data from the repository 128 to turn or convert that raw information into facts for the Al processor 132 to consume and process. The fact builder 146 can generate at least 100 different types of facts about Agile projects, in various embodiments, and more facts can be added at any time—and facts can be modified or removed as well. The goal builder 148 processes and analyzes the facts created by the fact builder 146 and uses that information to set or assign goals linked to expert instruction materials. Goals can be created in increasing difficulty, in accordance with the deliberate practice loop of FIG. 3. The goal tracker 150 is responsible for tracking the software team's progress toward a goal and marking or flagging it as complete when done. Once a goal is complete, the goal builder 148 will create a new goal for the team.

The action processor 152 consumes and processes actions stored in the action repository 134 created by the Al processor 126, and interprets those actions. An action might be to update the DDTC website with information (component 156), send an alert or notification (component 158), post or publish a message on a Slack channel or other collaboration tool/service (component 160), or a litany of other known actions (154).

In various embodiments, all information in the DDTC system 100 can be consumed via a website 140. The web interface presents or displays all of the goals, expert instructions, feedback and alerts, facts, and other Agile project information in an easy to read/consume format. Information can also be processed and consumed via voice requests at component 142. As such, a user can speak through a voice service or assistant (e.g., Alexa™, Cortana™, Siri™, Google Assistant™, etc.) to interact and control aspects of the system 100. For example, a user could ask “when is my release predicted to be completed?,” “is our release on schedule?,” and the like, for recognition and processing by the system 100 as if a textual or other inputted instruction/information request was directed through the REST API 138.

Referring to FIG. 3, the DDTC platform 100 is configured and functions to train and coach organizations and individuals using deliberate practice loop-style training. The deliberate practice loop functionality of the present invention can comprise: (1) setting goals at step 170, (2) receiving expert instruction at step 172, (3) practicing or utilizing structured training at step 174, and (4) receiving immediate feedback based on results at step 176. Iterating through these four steps allows the development teams to efficiently and dynamically achieve peak performance.

After importing data from the Agile tool(s), the DDTC system 100 follows the four-step practice loop pattern as explained herein. The DDTC system 100 also continues to download the data from the Agile tool(s). These downloads can be periodic (e.g., every minute, 5 minutes, hourly, daily, etc.) or in real-time.

At step 170, the DDTC system 100 analyzes the imported data against a rules engine or Al processor as detailed herein. This step points out initial problems with the teams' backlogs, and outputs and suggests goals that can be set to improve based on the processing of the analyzed data.

At step 172, the DDTC system 100 delivers and outputs structured training materials or information (articles, short video clips, presentations, etc.) to one or more team members at the devices 102, targeted to their specific goals. The training materials can be stored locally as part of a DDTC system database for access and processing, or the DDTC system 100 can access these resources from one or more remote databases networked with the system.

These training modules explain to the individuals not just what to do, but the Agile principles behind why the change is important. In this way, the DDTC system 100 trains the entire organization throughout the life of the team.

At step 174, practice or a “sprint” (e.g., 2-4 week period of time to complete a goal) is performed. This is the software development form of “structured training,” the purpose being that training and coaching are most effective when the team is doing real work. The team develops and tests its software for a short period of time. During the sprints, the DDTC system 100 processes and monitors the backlog for changes and makes recommendations based on the changes by continually processing and analyzing the data against the Al processor to generate action.

The system 100 provides immediate feedback, based on results, at step 176. After the sprint, the DDTC system 100 analyzes the updated data through the Al processor, gives the team feedback based upon the Al processor analysis, and again processes and outputs or serves training articles, videos, or other presentation materials, to the analytical results.

The DDTC system 100 employs artificial intelligence, machine learning, and expert system algorithms to point out potential issues that require improvement. These suggestions can be selected as goals for the next sprint, and the DDTC system 100 tracks the progress against these goals. Training materials (or links thereto) are sent to individual team members and can also be made available at the software dashboard, or via other menu or display options.

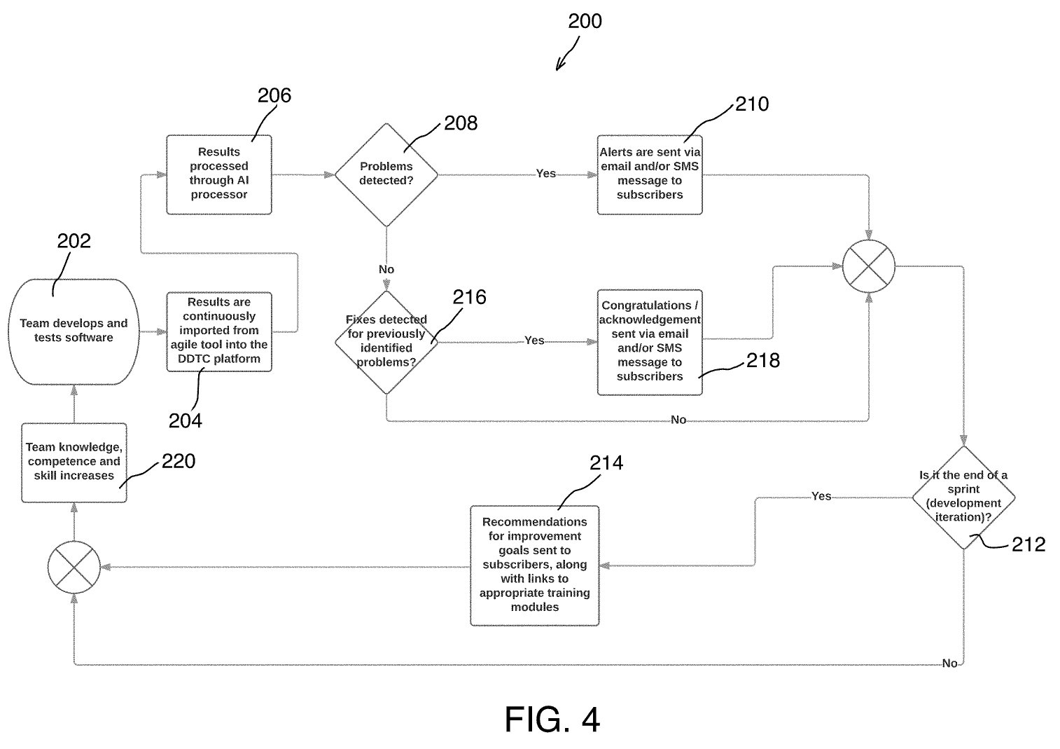

FIG. 4 illustrates an exemplary team training and coaching process 200 for the DDTC system 100. The software development team develops and tests the software being developed at step 202. The Agile development tools generate and provide data that is stored in the respective tool's databases. The tool-generated data is continuously imported into the DDTC's database 108 at step 204. The imported data is then processed through the Al processor at step 206.

If a problem is detected in the data by the Al processor at step 208, then an alert or notification can be sent (e.g., via text/email message, or other electronic message) to the appropriate individuals or systems at step 210. Further, the Al processor can detect fixes for previously-identified problems according to step 216. A congratulatory or acknowledgement message can be sent to the appropriate persons at step 218.

Once the end of a sprint (development iteration) is reached (step 212), the Al processor is programmed to provide recommendations output for improvement goals and send those recommendations to the appropriate personnel or devices along with links to training materials that correspond to the improvement goals, at step 214. Thus, the team knowledge, competence, and skills are increased (step 220).

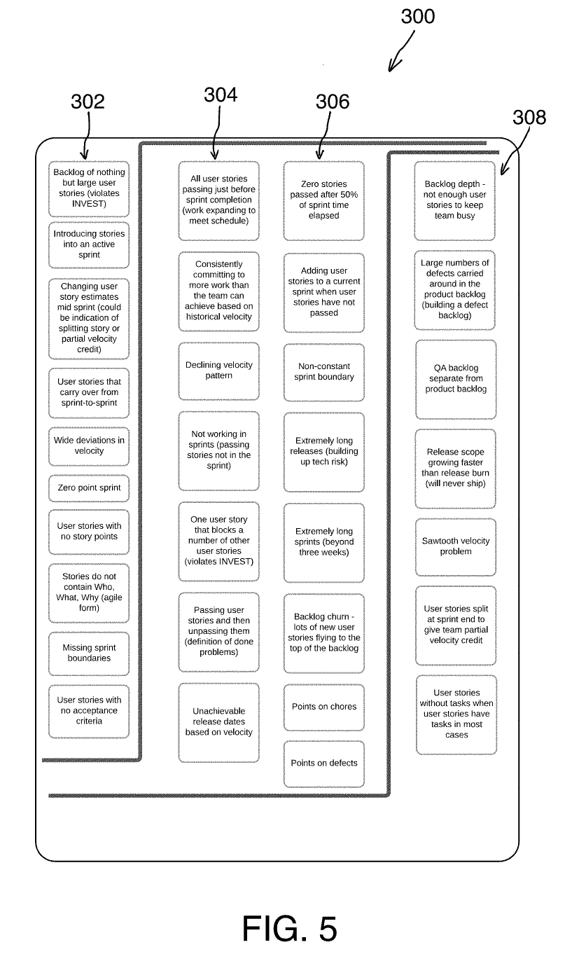

FIG. 5 illustrates exemplary “rules” 300 employed in the artificial intelligence processor or rules engine of the DDTC system 100 for various embodiments. Each block can represent a specific rule. The data imported into the DDTC system 100 is processed and run through each of the stored software rules with each data upload cycle. If the data violates any of the rules, then the particular violated rules are flagged so that the alert message or notification 210 can be sent and the situation remedied by the responsible individuals. While the various exemplary rules are depicted in groupings 302-208, other groupings, rules within particular groupings, and combinations thereof, can be included without deviating from the spirit and scope of the present invention.

In addition, the rules violations during a sprint can be logged in the DDTC system's memory or storage and subsequently processed and analyzed for patterns, and used to generate relevant training materials to the team and responsible individuals.

The Al processor is highly adaptable and customizable. For example, new rules can be added and selected rules can be omitted. Rules can also be categorized and weighted for various purposes. For example, certain rules may have a greater criticality than others, so the corresponding notification or alert can be tailored accordingly. Also, the scrum master (e.g., project leader) may wish to be alerted to certain rules violations, but not others. The Al processor is configurable to address these issues and dynamic considerations.

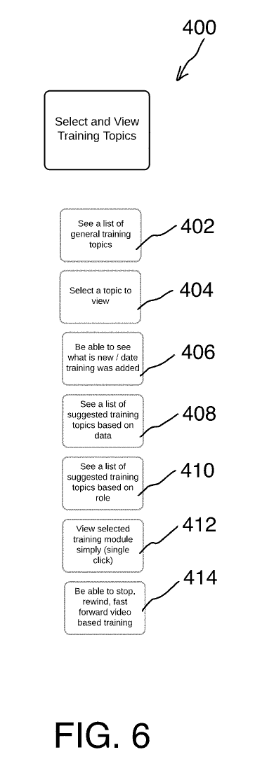

FIG. 6 illustrates a series of demonstrative options that may be presented to the user for manual training selection. Any one, or a combination of more than one, of these user-selectable training requests can be provided to the user at their system interface (e.g., devices 102) as a dashboard, as a drop-down list, or in a myriad of other display formats and outputs. In accordance with embodiments of the present invention, the training topics can include viewing a list of general training topics (402), selecting a topic to view (404), viewing what is new and the date the training was added (406), viewing a list of suggested training topics based on data through the system (408), viewing a list of suggested training topics based on roles (410), viewing selected training modules via a single click or selection (412), and controlling video or other training presentations (414). Obviously, other options and selections can be presented to the user consistent with the monitoring and teaching functionality and purpose of the present invention.

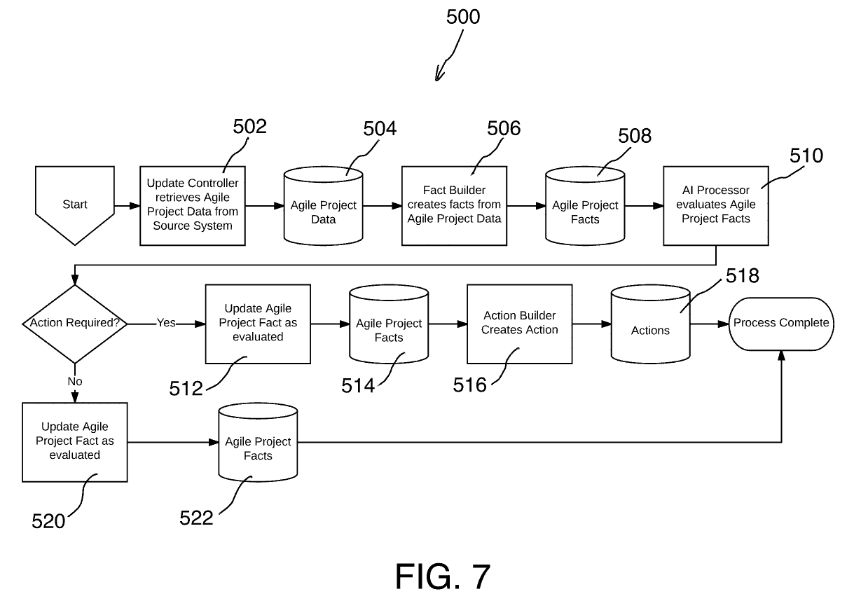

FIG. 7 illustrates the general method or logic steps 500 for using Agile data to derive facts and create actions, in accordance with embodiments of the present invention. At step 502, the update controller interfaces with and is responsible for polling source systems (e.g., CA Agile Central™, Atlassian Jira™, Microsoft TFS™, etc.) to receive new or updated software project data. This information is then mapped into a unique or proprietary data structure and stored in the agile project data repository 504 of the system 100. The update controller operates on a scheduled basis and the periods of operation can be defined by the user during the setup process.

The Agile project data repository 504 contains all the customer Agile project data and audit records of that data. The system 100 tracks changes to Agile data as it occurs over time and that temporal information is used by the fact builder to process and create facts of a temporal nature.

At step 506, the fact builder analyzes Agile project data and processes and turns that raw information into facts for the Al processor to process/consume. In various embodiments, the fact builder is configured to generate over 100 different types of facts about Agile projects. Facts can be modified, added, or removed as desired by users.

Steps 508, 514, and 522 represent the Agile project facts in the system repository, that contain all the facts that the fact builder gleans from Agile project data (e.g., over 100 types of facts). Some of these facts are very simple such as the number of “story points” (method of sizing software features) in a software release, while others are more complex, like the predicted delivery date of a release based on project “velocity” (the amount of work or capacity for a team during a sprint). This fact data is audited by the system 100 to process and understand how facts pertain to a project change over time.

Processing and evaluation of the Al processor is demonstrated at step 510. The Al processor is the embodiment of Al routines (e.g., expert rules, machine learning, etc.) as these routines pertain to Agile coaching and “scrum” (subset framework for Agile development) best practice. The Al processor processes and evaluates the facts produced by the fact builder 506 and then generates and outputs actions for the action processor as described herein.

While processing and evaluating facts, the Al processor is analyzing to determine if an action is required. An action can be as simple as sending a notification alert, or it can include more complex processing such as generating a sprint end report.

As illustrated in steps 512 and 520, project facts can be updated. As facts are processed, the system 100 can flag them as being evaluated such that spurious actions are not generated—such as evaluating the same fact in the same context more than once. If a fact changes then the present invention can flag and reevaluate, and reprocess, the fact via the Al processor.

An action builder processes a fact and creates an action from that fact at step 516. The action might be to generate an alert, update the website, generate a sprint end report, and a myriad of other related or relevant actions. The action repository is represented at step 518, with the action repository holding all the actions the Al processor creates to provide feedback to the team as they are sprinting, per the deliberate practice loop (see FIG. 3). The feedback is linked to expert instruction materials stored in the content repository, or other storage and databases.

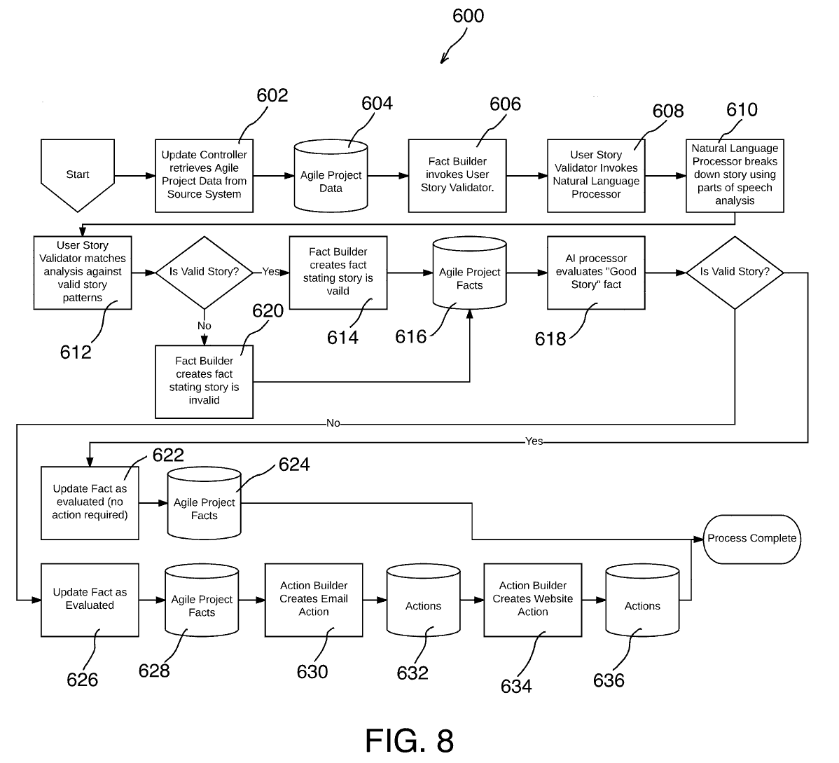

FIG. 8 illustrates the method or logic steps 600 for using Agile data to derive facts and create in accordance with a specific “good user story” example for the present invention. At step 602, the update controller interfaces with and is responsible for polling source systems (e.g., CA Agile Central™, JIRA™, Microsoft TFS™, etc.) to receive new or updated software project data. This information is then mapped into a unique or proprietary data structure and stored in the Agile project data repository 604 of the system 100. The update controller operates on a scheduled basis and the periods of operation can be defined by the user during the setup process.

The Agile project data repository 604 contains the customer Agile project data and audit records of that data. The system 100 tracks changes to Agile data as it occurs over time and that temporal information is used by the fact builder to process and create facts of a temporal nature.

At steps 606, 614, and 620 the fact builder analyzes Agile project data and processes and turns that raw information into facts for the Al processor to process/consume. In various embodiments, the fact builder is configured to generate over 100 different types of facts about Agile projects. Facts can be modified, added, or removed as desired by users.

The user story validator processes, analyzes, and is responsible for verifying whether a user story is valid, as demonstrated at steps 608 and 612. Typically, “good stories” have the form of “As a [who], I want to [what] so that [why]”—e.g., the “who,” “what,” and “why.” The system 100 breaks stories down into parts of speech and then processes the parts-of-speech pattern matching to determine whether a story is valid or not.

The natural language processor 610 is responsible for reading and processing text and breaking that text down into a series of parts of speech tags. In certain embodiments, these tags follow the Penn Treebank tag set. Other methodologies and techniques can be employed as well without deviating from the spirit and scope of the present invention.

The system 100 processes and evaluates the user story validator results and captures whether the story is valid or not as a fact (see processes 614 and 620).

The agile project fact repository, as represented with steps 616, 624, and 628, contains the facts that the fact builder gleans from agile project data (e.g., over 100 types of facts). Some of these facts are very simple, such as the number of story points in a software release, while others are more complex, like the predicted delivery date of a release based on project velocity. This fact data is audited by the system 100 to process and understand how facts pertain to a project change over time.

The Al Processor of step 618 is the embodiment of Al routines (expert rules, machine learning, etc.) as these routines pertain to Agile coaching and scrum best practice. The Al processor processes and evaluates the facts produced by the fact builder and then generates and outputs actions for the action processor. As the Al processor is processing and evaluating the “good story” fact, it will create actions (e.g., such as notifications, alerts, etc.) if a bad story is detected.

Project facts are updated at steps 622 and 626. As facts are processed, the system 100 can flag them as being evaluated such that spurious actions are not generated—such as evaluating the same fact in the same context more than once. If a fact changes then the present invention can flag and reevaluate, and reprocess, the fact via the Al processor.

The action builder, at steps 630 and 634, processes a fact and creates an action from that fact. The action might be to generate an alert, update the website, generate a sprint end report, and a myriad of other related or relevant actions.

As demonstrated at steps 632 and 636, the action repository stores the actions the Al processor creates to provide feedback to the team as they are sprinting, per the deliberate practice loop (see FIG. 3). The feedback is linked to expert instruction materials stored in the content repository, or other storage and databases.

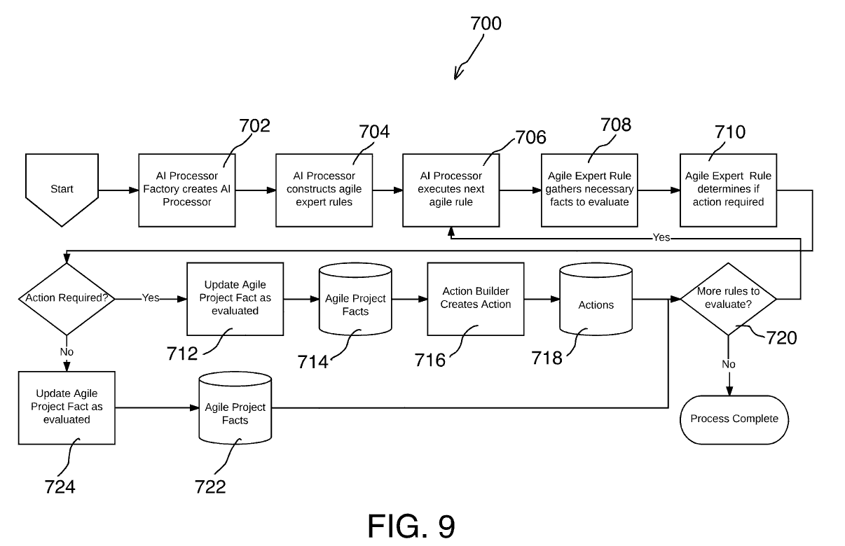

FIG. 9 illustrates the processing and functionality of the Al processor 700 of the system 100, in accordance with embodiments of the present invention. The Al processor factory 702 is responsible for creating an instance of an Al processor.

The Al Processor (as depicted at 704 and 706), and as described herein, is the embodiment of Al routines (expert rules, machine learning, etc.) as these routines pertain to Agile coaching and scrum best practice, and processes and evaluates the facts produced by the fact builder to create actions for the action processor.

As shown at steps 708 and 710, the Al processor operates on a plurality of stored and modifiable Agile expert rules. Each rule encapsulates the expertise of Agile coaches gained through many years of experience elevating the performance of software engineering teams. The rules read and process facts derived from Agile data. As the Al processor is processing and evaluating facts, it is always determining if an action is required—e.g., the need to send an email alert, generate a sprint end report, and the like.

As facts are processed, the system 100 flags those facts as evaluated to avoid generating spurious actions, as shown at steps 712 and 724. If the fact changes then the system 100 resets the flag and reprocesses and reevaluates the fact at the Al processor.

Referring to steps 714 and 722, the Agile project fact repository contains the facts that the fact builder gleans from Agile project data (e.g., over 100 types of facts). Again, some of these facts are very simple, such as number of story points in a release, and some are more complex, such as the predicted delivery date of a release based on project velocity. This fact data is audited by the system 100 to process and understand how facts pertain to a project change over time.

The action builder of step 716 is responsible for processing a fact to create an action from that fact, such as generating an alert, updating a website, generating a report, and the like. As shown with step 718, the action repository holds the actions the Al processor creates to provide feedback to the team as they are sprinting. The feedback is linked to expert instruction materials stored in the content repository, or other storage and databases.

The Al processor can process and evaluate rules one at time at step 720 for each Agile project until there are no more rules to evaluate. If there are more rules to evaluate, the next rule is executed starting at step 706.

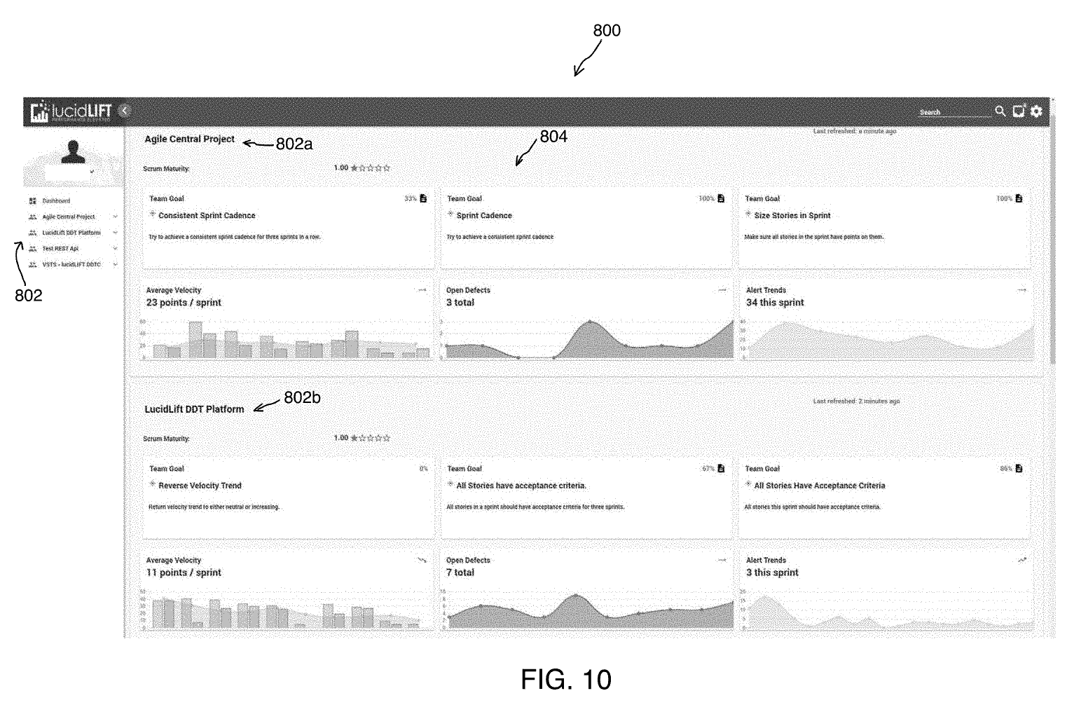

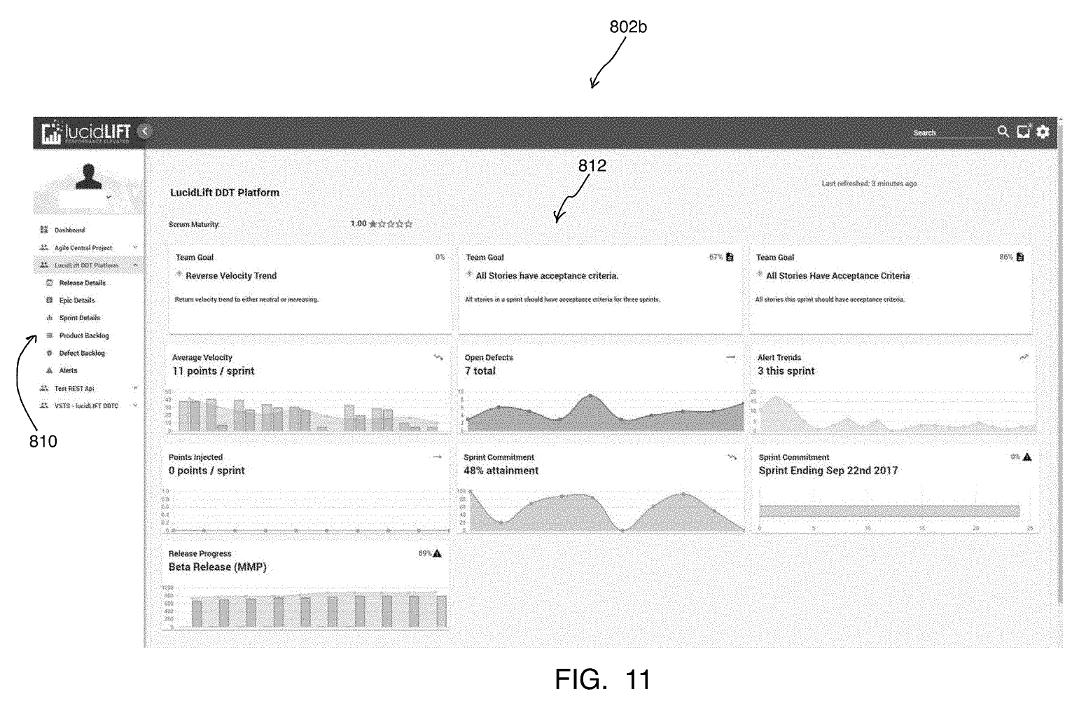

Reports and other outputs on the status and effectiveness of each software team are generated by the DDTC system 100 and are available on a user interface dashboard 800 (see FIG. 10), or various other system 100 menus and submenus, and can also be sent directly to subscribers via an electronic message or other communication technique if desired. Reports may include, but are not limited to, the following:
The amount of work that each team has completed during a specific period of time (during a “sprint”) versus the amount of work that the team committed to doing.
The predicted date that a project will be completed, based on the average speed of the team and the amount of work left to be completed.
A list of the work items that are currently being worked on by each team.
A list of the most current alerts generated by each team, indicating what problems each team may be having.

As detailed herein, traditional training is only marginally effective at ensuring Agile success, since the information is delivered all at one time, often before participants have had to do any real work. Often, the entire team is not trained, particularly new team members. The DDTC system 100 solves this problem by delivering real-time, continuous training to the entire team. The DDTC system 100 overcomes the limitations of coaching, because the platform can be everywhere and available at one time, and it can stay with the team indefinitely. Further, the system 100 can be delivered at a fraction of what a single Agile coach would cost. The present invention does not replace the current Agile tools but instead works with and extracts information and data directly from these tools to improve their usefulness by improving the way they are used, and the data that is put or inputted into them. Thus, an organization does not need to pick a single tool in order to have enterprise reporting capability; The DDTC system 100 can work with multiple tools at once, so each team can pick the tool that works best for them.

Executives, managers, coaches, and team members, in any combination, can use the DDTC system, platform, and methods of the present invention.

The aforementioned implementation of the data-driven training and coaching platform and system was discussed herein specifically with respect to Agile software development and development teams. However, the same platform and system can be adapted to, or easily implemented with, any number of other disciplines or industries as well. For example, the system 100 of the present invention can be implemented to integrate with and assist sales teams, infrastructure teams that utilize ITIL/ITSM (to provide guidance on processes), corporate finance teams (to analyze data, identify issues or problems, and recommend steps to remediate), personal finance teams (to analyze personal financial information, identify issues or problems, and establish goals for retirement, savings, planning, etc.), and a variety of other industries and disciplines where the features of the system's analysis, teaching, and coaching would provide benefits.

In an alternative embodiment, the DDTC system 100 disclosed herein may be implemented for use with a sales team (products or services). In this embodiment, the data source, instead of team requirements backlogs, would be data from a sales database (e.g., SalesForce.com™ and the like) and an automated call distribution database. Data would be imported into the conversion tool, and stored in cloud storage. Rules specific to the inside sales discipline would be loaded into the Al processor, and coaching tips and training modules would be distributed to subscribers via the action processor, putting employees into the deliberate practice training loop, as illustrated in FIG. 3.

The DDTC system 100 can be adapted to virtually any discipline in which performance, projects, goals, or other related data is available, or for which training is traditionally done online or in a classroom setting.

FIGS. 10-15 show various exemplary screenshots of user menus and submenus for the DDTC system 100. As shown in FIG. 10, a main dashboard 800 is provided that summarizes the projects loaded into the system 100 for a particular organization or team. The dashboard 800 can include screen or display regions, including a project identification region 802. The dashboard can include various graphical (804) and textual summaries for all and/or individual projects. Exemplary projects 802a and 802b are shown for this particular embodiment, but other visual layouts, menus, data and information presentations, and the like, are envisioned for use with present invention as well. For various embodiments, the graphics and/or text can be summary representations of sprint cadence, stories in sprint, average velocity, open defects, alert trends, scrum maturity, and various other information.

FIG. 11 shows an exemplary screenshot of a particular project 802b within the system 100. In various embodiments, the specific project dashboard or project summary area 802b can be an expanded view of the project identification region 802 of FIG. 10—for this example, the project is one of several and is identified/named “LucidLift DDT platform.” As such, a project specific region 810 can include summary information and categories related to release details, epic details, sprint details, project backlog, defect backlog, and alerts. Other summary items that relate to the information, features, and processing considerations of the system 100 can be outputted or displayed as well. Region 812 can include various graphical and textual summaries for the individual project selected or highlighted. Again, sprint, story, and release information can be presented in this region.

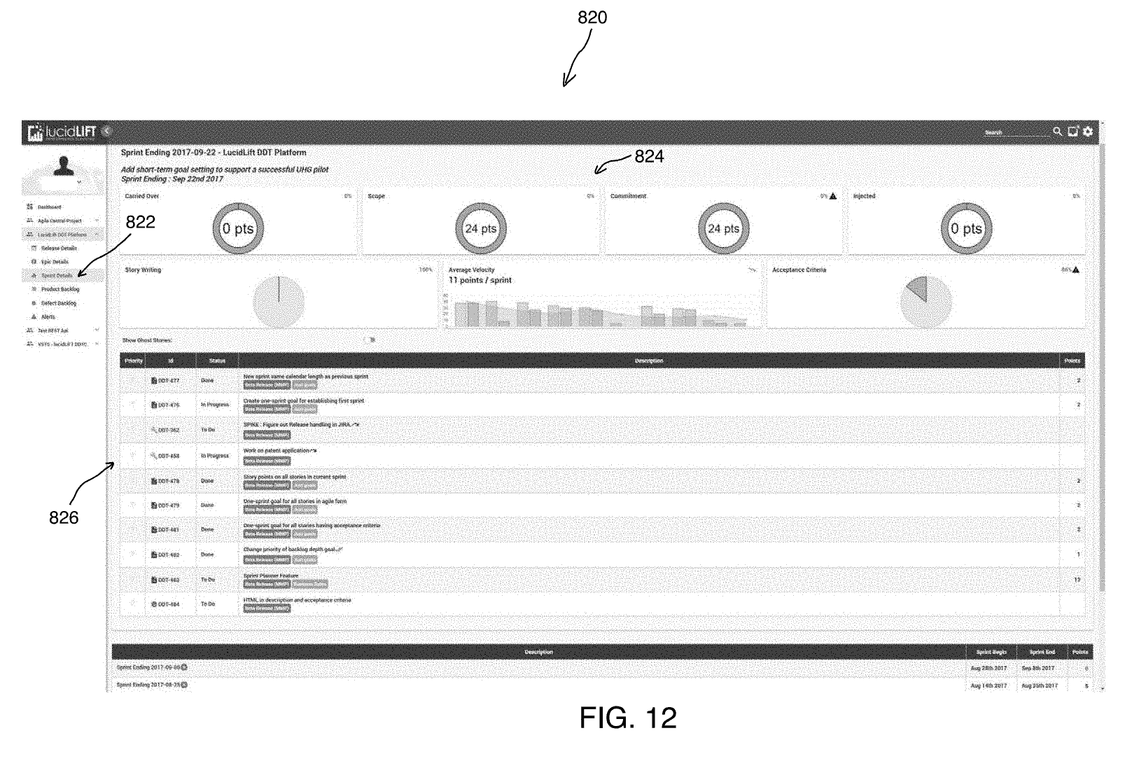

Referring to FIGS. 12-15, exemplary and summary submenus 820 for a particular project are shown. For instance, FIG. 12 illustrates a “sprint details” submenu 822 with a graphical display region 824 and a textual display region 826. This particular submenu displays details for the current sprint for a project. A sprint is a block of time (e.g., 2-4 weeks) in which the team commits to getting particular work completed. The information provided in region 824 or 826 can indicate a problem/issue for the team to resolve with an icon, such as a dark or black icon, featuring an exclamation point icon. The icon or other highlighted indicia can link to content within the system 100 that describes what needs to be fixed. This same indicia or icon methodology can be presented for highlighting problem/issue identification throughout the various menus and submenus.

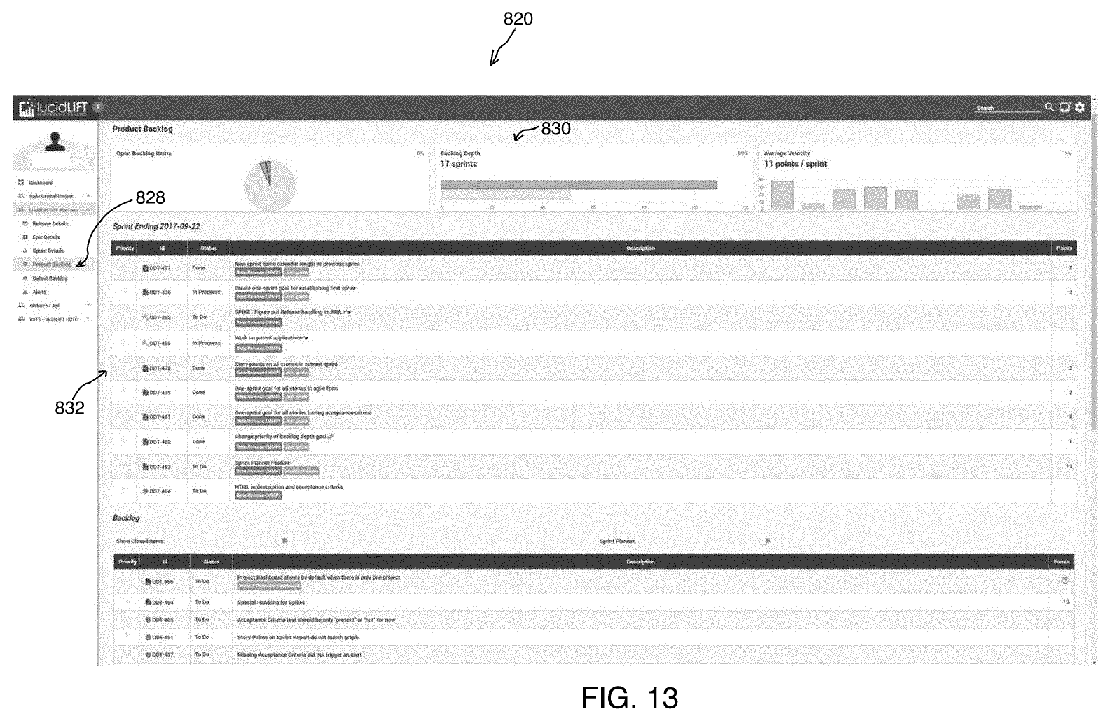

FIG. 13 illustrates a “product backlog” submenu 828 with a graphical display region 830 and a textual display region 832. This particular submenu displays details of the work that is needed for a particular software product. The information provided in region 830 or 832 can indicate a problem/issue for the team to resolve.

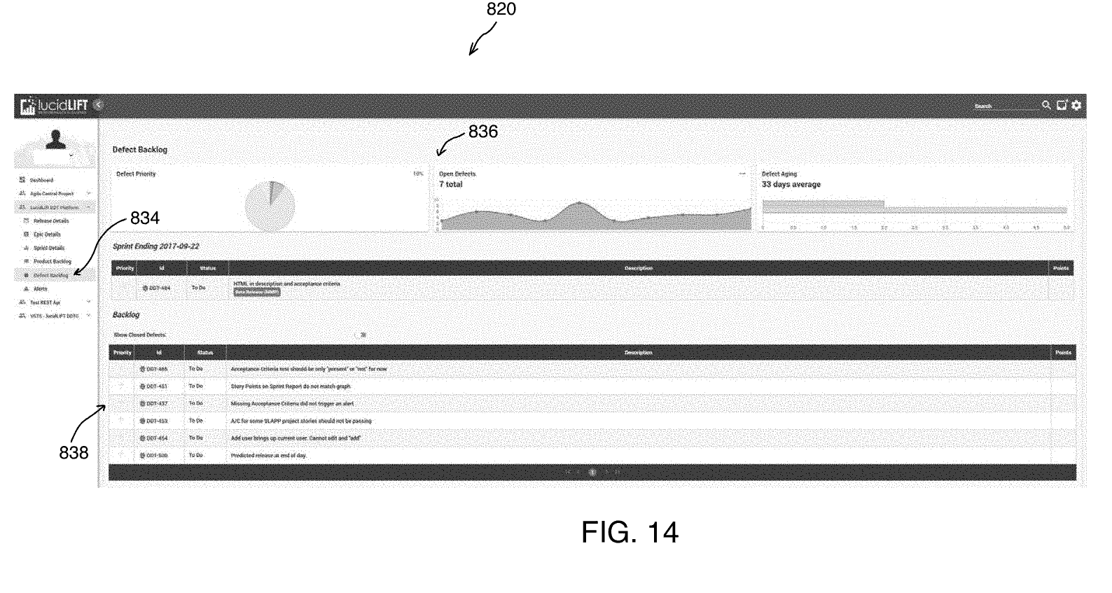

FIG. 14 illustrates a “defect backlog” submenu 834 with a graphical display region 836 and a textual display region 838. This particular submenu displays and represents the defects against a software project reported by users/customers, or other people in the organization or team. The information provided in region 836 or 838 can indicate a problem/issue for the team to resolve.

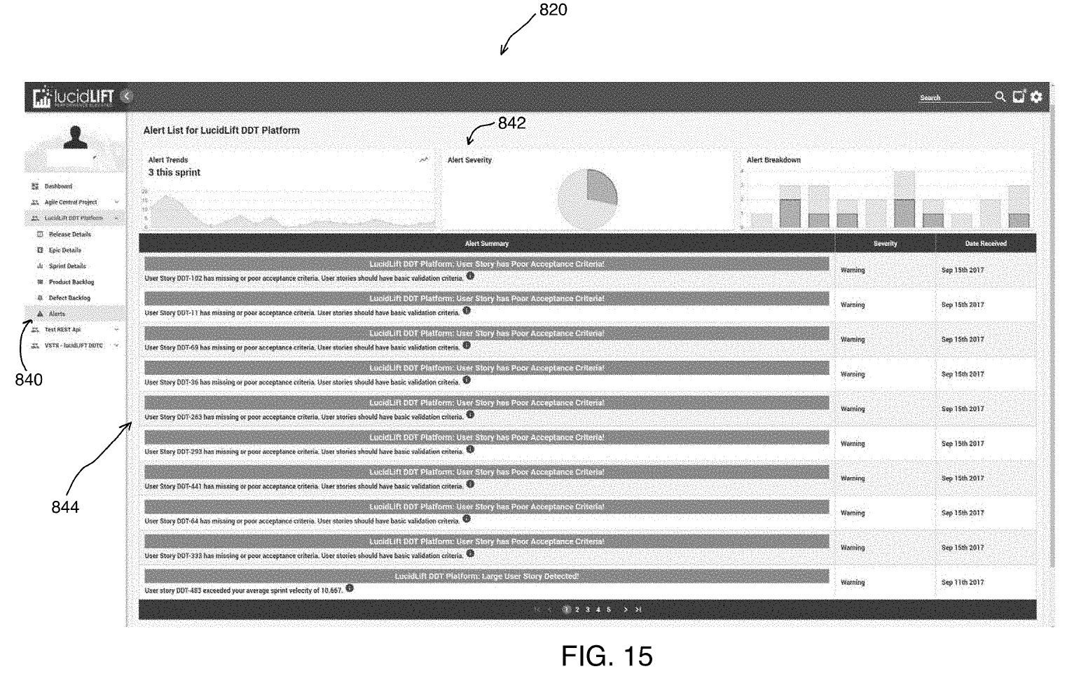

FIG. 15 illustrates an “alerts” submenu 840 with a graphical display region 842 and a textual display region 844. Alerts are the notifications sent out by the system 100 that are intended to correct behavior and can include links to content, or otherwise make content available to the users.

For various embodiments, the “epic details” submenu can include a summary of all epics for a project. An epic is a collection of user stories that represent some large feature. If a user clicks on or otherwise selects this heading, he or she can drill into the details for that epic. Similarly, a user can drill into specific release details or summaries by clicking on or otherwise selecting the “release details” heading.

Various devices or computing systems can be included and adapted to process and carry out the aspects, computations, and algorithmic processing of the systems 100 of the present invention. Computing systems and devices of the present invention may include a processor, which may include one or more microprocessors and/or one or more circuits. Further, the devices and computing systems can include a network interface. The network interface is configured to enable communication with the network 103, other devices and systems, and servers, using a wired and/or wireless connection.

The devices or computing systems may include memory, such as non-transitive memory, which may include one or more non-volatile storage devices and/or one or more volatile storage devices (e.g., random access memory (RAM)). In instances where the devices include a microprocessor, computer readable program code may be stored in a computer readable medium or memory, such as, but not limited to, a hard disk, a solid-state drive, optical media, memory devices (e.g., random access memory, flash memory), and the like. The computer program or software code can be stored on a tangible, or non-transitive, machine-readable medium or memory. In some embodiments, computer readable program code is configured such that when executed by a processor, the code causes the device to perform the steps described herein. In other embodiments, the device or computing device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The computing devices 102 may include an input device. The input device is configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, etc. The devices 102 can also include an output device. Examples of output devices include monitors, mobile device screens, tablet screens, speakers, remote screens, etc. The output device can be configured to display images, media files, text, or video, or play audio to a user through speaker output.

The server processing systems 105, 106, for use or connected with the systems 100 of the present invention, can include one or more microprocessors, and/or one or more circuits. A network interface can be configured to enable communication with the network 103, using a wired and/or wireless connection, including communication with devices or computing devices 102 disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to, a hard disk, a solid-state drive, optical media, memory devices, etc.

The present invention can be embodied as software code residing on a user's computing device 102 (e.g., desktop, tablet, mobile, and the like) and/or on the server 105, 106. The various data of the present invention can be included on and transferred to and from a storage area network (SAN), a data cloud, or any computing device for storing the files or data being uploaded, downloaded, or processed.

Aspects of the software code of the invention can take the form of a plugin or app, and can interface with various protocols or software using APIs or other means of interacting with computing software and systems.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A data-driven training and coaching system, comprising:
a processor;
a non-transitory memory operatively coupled to the processor;
an update controller component in operative communication with an Agile toolset data source and an Agile project database such that the update controller component extracts data from the Agile toolset data source and stores project data to the Agile project database;
a fact builder component configured to create one or more project facts from the Agile project database; and
an artificial intelligence processor component configured to process the one or more project facts and generate one or more actions, with the one or more actions including providing training information.

2. The system of claim 1, wherein at least the Agile project database includes data cloud storage.

3. The system of claim 1, wherein the one or more actions are further facilitated by an action processor component.

4. The system of claim 3, wherein the one or more actions includes sending an electronic message.

5. The system of claim 4, wherein the electronic message is an SMS message.

6. The system of claim 4, wherein the electronic message is an email message.

7. The system of claim 3, wherein the one or more actions includes publishing data to a website.

8. The system of claim 1, further including a goal tracker component configured to monitor goal data.

9. The system of claim 8, wherein the goal tracker component is configured to flag a completion status for a project.

10. A method of training and coaching software development teams, comprising:
providing an Agile toolset data source and an Agile project database such that a software controller component extracts data from the Agile toolset data source and stores project data to the Agile project database;
creating one or more project facts from the Agile project database; and
processing the one or more project facts at an artificial intelligence processor component and generating one or more actions, with the one or more actions including providing training information.

11. The method of claim 10, wherein at least the Agile project database includes data cloud storage.

12. The method of claim 10, wherein the one or more actions are further facilitated by an action processor component.

13. The method of claim 10, wherein the one or more actions includes sending an electronic message.

14. The method of claim 13, wherein the electronic message is an SMS message.

15. The method of claim 13, wherein the electronic message is an email message.

16. The method of claim 10, wherein the one or more actions includes publishing data to a website.

17. The method of claim 10, further including monitoring project goals at a goal tracker component.

18. The method of claim 10, further including receiving one or more data requests via a representational state transfer application programming interface.

19. The method of claim 18, wherein the one or more data requests are received from a website.

20. The method of claim 18, wherein the one or more data requests are received from a voice interface component.
